(19) United States
(12) Patent Application Publication
(10) Pub. No.: US 2010/0028111 A1
(43) Pub. Date: Feb. 4, 2010

(54) Variable-Size Load Port and Method for Operating the Same

(75) Inventors: Michael Krolak, Los Gatos, CA (US); Anthony Bonora, Portola Valley, CA (US); Ted Rogers, Alameda, CA (US)

Correspondence Address: MARTINE PENILLA & GENCARELLA, LLP, 710 LAKEWAY DRIVE, SUITE 200, SUNNYVALE, CA, 94085, US

(73) Assignee: Asyst Technologies, Inc., Fremont, CA (US)

(21) Appl. No.: 12/184,194

(22) Filed: Jul. 31, 2008

(51) Int. Cl. B65G 65/34

(52) U.S. Cl. 414/411; 414/810

(57) ABSTRACT

A variable-size load port includes a port door defined to cover an effective aperture of the load port. A vertical positioning device is connected to the port door to provide for controlled vertical positioning and movement of the port door without substantial horizontal movement of the port door. A seal plate is disposed above the port door. The seal plate is defined to form a proximity seal with an upper surface of the port door when the port door is vertically positioned in proximity to the seal plate. The seal plate is defined to be adjustable in a vertical direction.

### BACKGROUND OF THE INVENTION

During semiconductor manufacturing, a semiconductor wafer undergoes a plurality of process steps, each of which are performed by a specialized process tool. Pods are used to convey semiconductor wafers from one tool to another. An exemplary type of pod is referred to as a front-opening unified pod (FOUP). Each pod is capable of transporting a number of wafers of a specific diameter. For example, for wafers of 300 mm, a conventional FOUP has a capacity of 25 wafers, and can therefore carry 25 or fewer 300 mm wafers at a time. The pods are designed to maintain a protected internal environment to keep the wafers free of contamination, e.g., by particulates in the air outside the pod. Pods are also known for conveying other types of substrates, such as liquid crystal panels, rigid magnetic media for hard disk drives, etc.

A lot size is the number of wafers being processed as a group. A pod having a maximum capacity of 25 substrates is appropriate for a lot sizes of 25 or fewer, since an entire lot can be kept together during processing and be conveyed from one tool to another in a single pod. However, some fabricators in the semiconductor field are moving to reduce their lot size for a variety of reasons. Storing a 10-wafer lot in a pod designed for 25 wafers can be space-inefficient, resulting in a greatly reduced wafer storage density. In a fabrication facility where floor space can be precious, it may be desirable to increase the storage density by storing the wafer lots in smaller size pods, each having a smaller maximum capacity e.g., 8 or 10 wafers each, and also smaller outside dimensions. However, each pod is designed specifically to interface with a particular load port in each tool. Therefore, simply resizing the pod would result in an incompatibility between the pod and the load port.

FIG. 1 shows a conventional load port 10 configured to interface with a standard 300 mm, 25-wafer pod 70. Load port 10 is attached to a front end of a process tool as described, for example, with reference to FIGS. 1 and 2 of U.S. Pat. No. 6,502,869, which issued Jan. 7, 2003 to Rosenquist et al., and is incorporated herein by reference in its entirety. For purposes of description, the “front” of load port 10 is the side of load port 10 facing the positive Y direction as indicated by coordinate axes 21. The “front” of pod 70 is the side facing the front of load port 10.

Load port 10 includes a tool interface 20. In the semiconductor industry, tool interface 20 is often in conformance with an industry standard referred to as “Box Opener/Loader-to-Tool Standard Interface” (BOLTS), commonly referred to as a BOLTS interface or a BOLTS plate. Tool interface 20 includes an aperture 22 surrounded by a recessed shoulder 24. Aperture 22 is substantially occluded by a port door 30. Port door 30 forms a proximity seal with a boundary of aperture 22 to prevent contaminates from migrating to the interior 40 of the process tool. A proximity seal provides a small amount of clearance, e.g., about 1 mm, between the parts forming the proximity seal. The small clearance of the proximity seal allows air at a higher pressure to escape from the interior 40 of the process tool and sweep away any particulates from the sealing surfaces of the proximity seal.

Load port 10 also includes an advance plate assembly 50 having an advance plate 52. In one embodiment, registration pins (not shown) mate with corresponding slots or recesses in the bottom support 72 of pod 70, to facilitate alignment of the pod 70 on the advance plate 52. Pod 70 may conform to industry standards for Front Opening Unified Pods (FOUPs) or a different standard. Advance plate assembly 50 has an actuator (not shown) that slides advance plate 52 in the Y direction between the retracted position shown in FIG. 1 and an advanced position that brings pod 70 into close proximity with tool interface 20. When pod 70 is in the advanced position, the front surface 76 of flange 75 forms a proximity seal with recessed shoulder 24 of tool interface 20.

A front surface 34 of port door 30 includes a pair of latch keys 60. Latch keys 60 include a post that extends away from port door 30 and is substantially perpendicular to port door 30, and a crossbar at the distal end of the post. The crossbar extends perpendicularly to the post to form a “T” therewith. Port door 30 includes an actuator that interacts with latch keys 60, causing latch keys 60 to rotate on the axis of the post. As pod 70 moves to the advanced position, latch keys 60 are inserted into corresponding latch key receptacles (not shown) of a pod door 74 of pod 70. Latch keys 60 are then rotated on the axis of the post, thereby interacting with a mechanism (not shown) internal to pod door 74, causing pod door 74 latches to disengage from flange 75 of pod 70. An example of a door latch assembly within a pod door adapted to receive and operate with latch keys is disclosed in U.S. Pat. No. 4,995,430, entitled “Sealable Transportable Container Having Improved Latch Mechanism,” which is incorporated herein by reference. Another example is presented in U.S. Pat. No. 6,502,869, issued on Jan. 7, 2003 to Rosenquist et al., also incorporated herein by reference. In addition to disengaging pod door 74 from the pod 70, rotation of the latch keys 60 locks the keys 60 in their respective latch key receptacles, thereby coupling the pod door 74 to the port door 30. A conventional load port includes two latch keys 60, that are structurally and operationally identical to each other. Additionally, alignment pins 36 are provided to facilitate alignment between port door 30 and pod door 74, so that pod door 74 will be sufficiently aligned to enable passage through the aperture 22 toward the process tool interior 40.

In the conventional load port 10, once the pod door 74 latches are disengaged from flange 75, the port door 30 is retracted in a horizontal direction by mechanism 32, as indicated by arrow 33, thereby removing the pod door 74 from the pod 70. Following retraction of the port door 30 (with pod door 74 coupled thereto) in the horizontal direction 33, the mechanism 32 is operated to moved the port door 30 (with pod door 74 coupled thereto) downward in a vertical direction, as indicated by arrow 35, thereby clearing the aperture 22 to enable unobstructed access from the process tool interior 40 to the wafers inside the pod 70.

### SUMMARY OF THE INVENTION

In one embodiment, a load port door is disclosed. The load port door includes a planar member defined to cover an effective aperture of a load port. The planar member is oriented to be substantially vertical. The vertically oriented planar member is defined by an upper surface, a lower surface, opposing side surfaces, a front surface, and a back surface. The front surface of the planar member is defined to interface with a door of a container. The bottom surface of the planar member includes an extension extending perpendicularly away from the front surface of the planar member. The load port door also includes a vertical positioning device connected to the planar member to provide for controlled vertical positioning and movement of the planar member without substantial horizontal movement of the planar member.

In another embodiment, a load port is disclosed. The load port includes a port door defined to cover an effective aperture of the load port. The load port also includes a vertical positioning device connected to the port door to provide for controlled vertical positioning and movement of the port door without substantial horizontal movement of the port door. The load port further includes a seal plate disposed above the port door. The seal plate is defined to form a proximity seal with an upper surface of the port door when the port door is vertically positioned in proximity to the seal plate. Also, the seal plate is defined to be adjustable in a vertical direction.

In another embodiment, a method is disclosed for operating a load port. The method includes an operation for adjusting a vertical position of a seal plate so as to form a proximity seal between the seal plate and a container, when the container is positioned under the seal plate. An operation is also performed to adjust a vertical closed position of a port door to align with the container, when the container is positioned adjacent to the port door. The method also includes an operation for moving the container horizontally toward the port door so as to position a door of the container adjacent to the port door, when the port door is in the vertical closed position. The method further includes an operation for operating the port door to engage the container door, so as to release the container door from the container and to secure the container door to the port door. An operation is also performed to retract the container horizontally away from the port door without substantial horizontal movement of the port door, so as to open the container and clear the container from a vertical movement path of the container door secured to the port door. Additionally, the method includes an operation for moving the port door, with the container door secured thereto, vertically downward without substantial horizontal movement of the port door, so as to provide unobstructed access to an interior of the opened container.

### BRIEF DESCRIPTION OF THE DRAWINGS

FIG. 1 shows a conventional load port configured to interface with a standard 300 mm, 25-wafer pod;

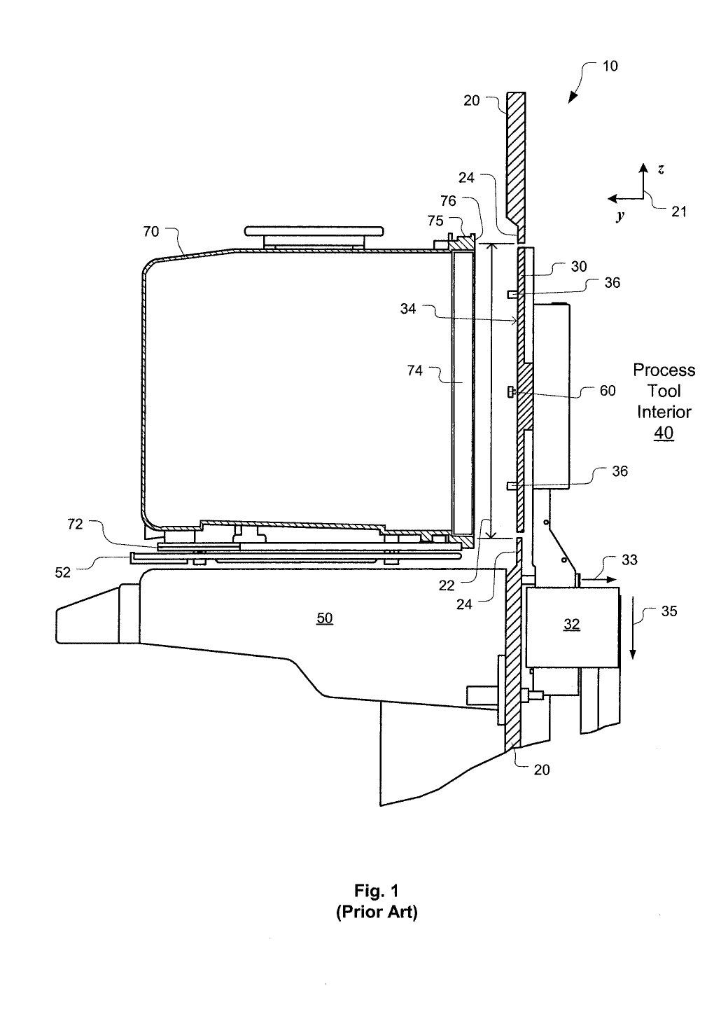

FIG. 2 is an illustration showing a side cross-sectional schematic view of a variable-size load port, in accordance with one embodiment of the present invention;

FIG. 3A is an illustration showing the load port with a container positioned on the advance plate of the advance plate assembly, in accordance with one embodiment of the present invention;

FIG. 3B is an illustration showing the advance plate moved toward the port door so as to position the container door adjacent to the front surface of the port door, in accordance with one embodiment of the present invention;

FIG. 3C is an illustration showing a top view of the container positioned adjacent to the port door, as shown in FIG. 3B, in accordance with one embodiment of the present invention;

FIG. 3D is an illustration showing the container moved away from the port door after securing the container door to the port door, in accordance with one embodiment of the present invention;

FIG. 3E is an illustration showing the port door with the container door secured thereto moved vertically downward by the vertical positioning device, in accordance with one embodiment of the present invention;

FIG. 3F is an illustration showing the container in the forward position following removal of the container door and lowering of the port door having the container door secured thereto, in accordance with one embodiment of the present invention;

FIG. 4A is an illustration showing the load port with a low-capacity container positioned on the advance plate of the advance plate assembly, in accordance with one embodiment of the present invention;

FIG. 4B is an illustration showing the advance plate moved toward the port door so as to position the low-capacity container door adjacent to the front surface of the port door, in accordance with one embodiment of the present invention;

FIG. 4C is an illustration showing the low-capacity container moved away from the port door after securing the low-capacity container door to the port door, in accordance with one embodiment of the present invention;

FIG. 4D is an illustration showing the port door with the low-capacity container door secured thereto moved vertically downward by the vertical positioning device, in accordance with one embodiment of the present invention;

FIG. 4E is an illustration showing the low-capacity container in the forward position following removal of the low-capacity container door and lowering of the port door having the low-capacity container door secured thereto, in accordance with one embodiment of the present invention; and

FIG. 5 is an illustration showing a method for operating the load port, in accordance with one embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

A variable-size load port for a process tool is disclosed herein. The variable-size load port can be used with essentially any process tool, and is specifically suited for use with a process tool requiring a clean process tool interior environment. For instance, in one embodiment, the variable-size load port can be used to provide an access portal to a semiconductor fabrication process tool. In this embodiment, the variable-size load port is configured to receive, support, and manipulate a container defined to house a number of workpieces, such that workpieces can be retrieved from or placed into the container by a robotic handler within the process tool without compromising a cleanliness of the process tool interior. Each workpiece can represent essentially any type of article formed through the semiconductor fabrication process. For example, a workpiece may represent a semiconductor wafer, a flat panel display, a solar panel, among many others. For ease of description, the term “workpiece” is used herein to refer to any type of article to be received into or retrieved from a process tool.

The container defined to interface with the variable-size load port disclosed herein can represent essentially any type of container defined to house a number of workpieces and equipped with a mechanically openable door. For example, the container may represent a Front Opening Unified Pod (FOUP), a Standard Mechanical Interface (SMIF) pod, a reticle container, a flat panel display transport device, among many others. For ease of description, the term “container” is used herein to refer to any type of container defined to house a number of workpieces and equipped with a mechanically openable door.

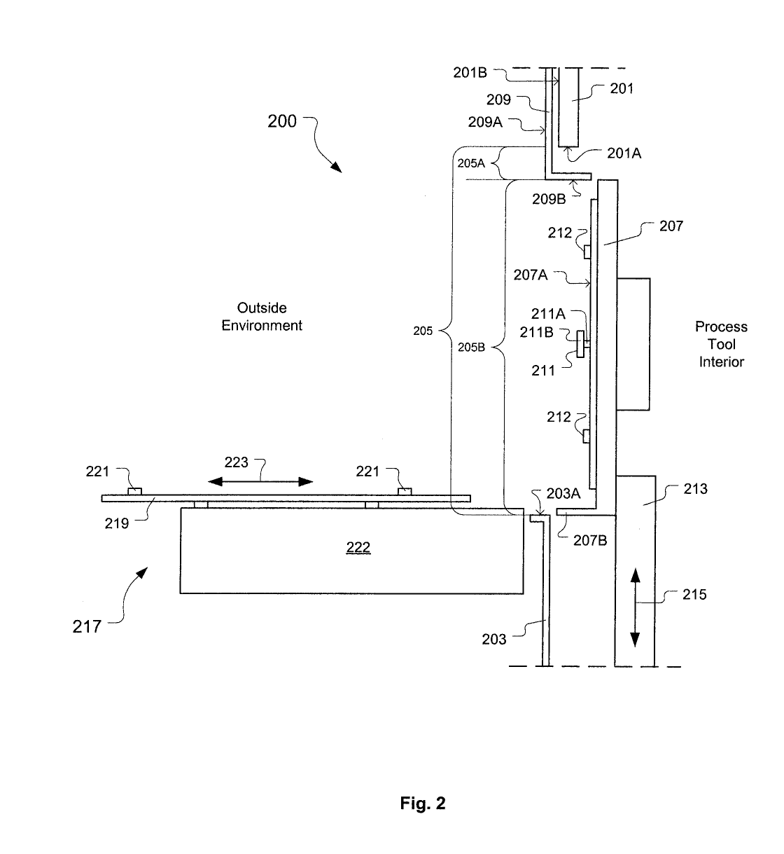

FIG. 2 is an illustration showing a side cross-sectional schematic view of a variable-size load port 200 (“load port” 200 hereafter), in accordance with one embodiment of the present invention. The load port 200 includes a port plate 201 and a BOLTS plate 203. An aperture 205 is defined between the port plate 201 and the bolts plate 203. More specifically, in the vertical direction, the aperture 205 extends from the lower edge 201A of the port plate 201 to the upper edge 203A of the bolts plate 203. A seal plate 209 is disposed on the outer side of the port plate 201. When viewed in side cross-section, the seal plate 209 includes a vertically oriented plate 209A and a horizontally oriented plate 209B so as to form an “L” shape. The vertically oriented plate 209A is secured to an outer surface 201B of the port plate 201. The horizontally oriented plate 209B extends below the lower edge 201B of the port plate 201 toward the process tool interior. The seal plate 209 position is adjustable in the vertical direction so as to occlude an upper portion 205A of the aperture 205, thereby reducing the vertical size of the aperture 205 to form an effective aperture 205B.

In various embodiments, the vertical adjustment of the seal plate 209 position can be performed either manually or remotely. Additionally, in one embodiment utilizing a remotely adjustable seal plate 209, a proper vertical position of the seal plate 209 can be achieved automatically by way of seal plate 209 position sensors and associated control circuitry/mechanisms. Because the vertical position of the seal plate 209 is adjustable, the effective aperture 205B is adjustable so as to afford the load port 200 with a variable-size capability for accommodating containers of different vertical size.

The load port 200 also includes a port door 207 defined to form a proximity seal about a periphery of the effective aperture 205B when the port door 207 is in a closed position, such as shown in FIG. 2. The port door 207 includes a bottom extension 207B oriented to extend toward the BOLTS plate 203. The bottom extension 207B forms the proximity seal between the port door 207 and the lower periphery of the effective aperture 205B, i.e., the upper edge 203A of the BOLTS plate 203. The proximity seal formed between the periphery of the port door 207 and the periphery of the effective aperture 205B provides a small amount of clearance to allow air from the process tool interior to flow through the proximity seal to the outside environment, thereby sweeping away particulates/contaminants from the sealing surfaces of the proximity seal. The driving force of the air through the proximity seal is provided by the air pressure differential between the process tool interior and the outside environment, wherein the air pressure in the process tool interior is higher than the air pressure in the outside environment.

In one embodiment, a front surface 207A of the port door 207 includes a pair of latch keys 211. Each latch key 211 includes a post 211A that extends away from the port door 207 in a substantially perpendicular manner, with a crossbar 211B at the end of the post 211A away from the port door 207. The crossbar 211B of the latch key 211 is oriented to be substantially perpendicular to the post 211 A of the latch key 211. The port door 207 also includes an actuator that interacts with the latch keys 211, causing each latch key 211 to rotate on the axis of its post 211A. Additionally, in one embodiment, alignment pins 212 are provided on the front surface 207A of the port door 207 to facilitate alignment between a container door and the port door 207, so that the container door will be able to pass through the effective aperture 205B between the seal plate 209 and the BOLTS plate 203.

The load port 200 further includes a vertical positioning device 213 connected to the port door 207. The vertical positioning device 213 enables controlled movement of the port door 207 in a vertical direction, as indicated by arrow 215. It should be appreciated that the vertical positioning device 213 is defined to provide for controlled vertical movement of the port door 207 with minimal, if any, horizontal movement of the port door 207. In one embodiment, port door 207 position sensors and associated vertical positioning device 213 control circuitry/mechanisms are utilized to provide precise control of the vertical position of the port door 207.

The load port 200 further includes an advance plate assembly 217 having an advance plate 219 upon which the container is received and supported while interfaced with the load port 200. In one embodiment, registration pins 221 are defined on the upper surface of the advance plate 219. The registration pins 221 are positioned to mate with corresponding slots or recesses in the bottom of the container when the container is positioned on the advance plate 219, thereby facilitating proper alignment of the container on the advance plate 219. The advance plate assembly 217 includes a horizontal positioning device 222 connected to the advance plate 219. The horizontal positioning device 222 enables controlled movement of the advance plate 219 in a horizontal direction, as indicated by arrow 223, thereby enabling controlled movement of the container (when supported on the advance plate 219) in the horizontal direction toward or away from the port door 207. In one embodiment, advance plate 219 position sensors and associated horizontal positioning device 222 control circuitry/mechanisms are utilized to provide precise control of the horizontal position of the advance plate 219.

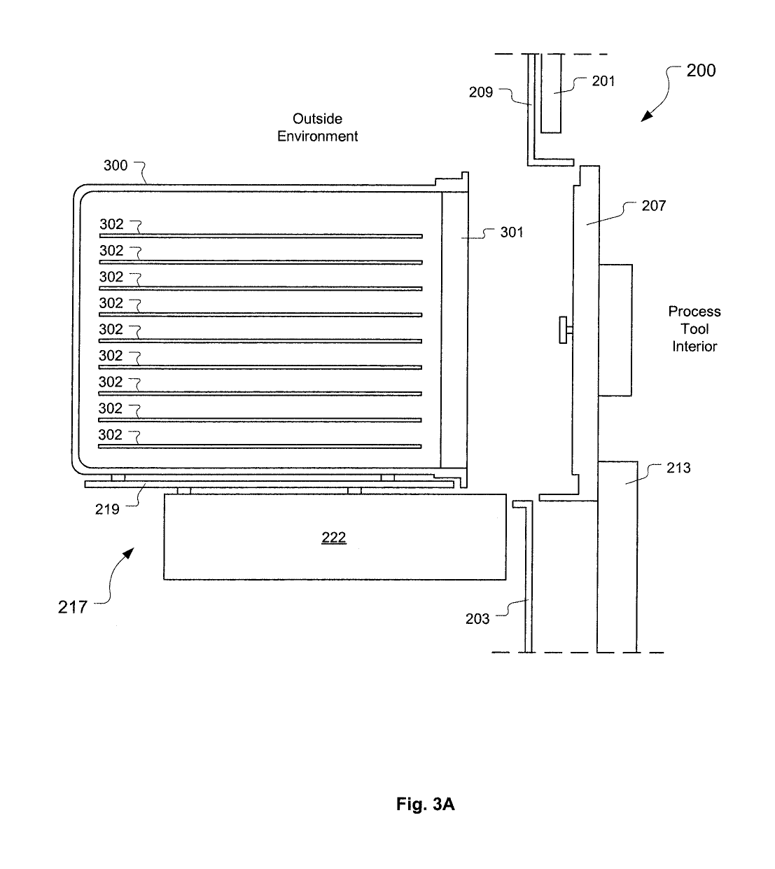

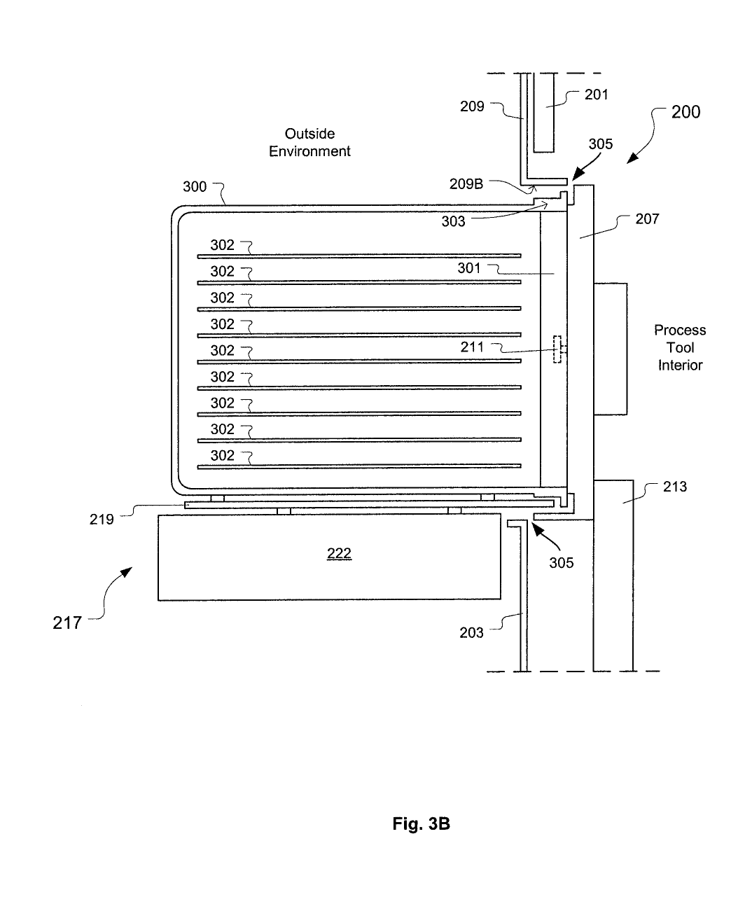

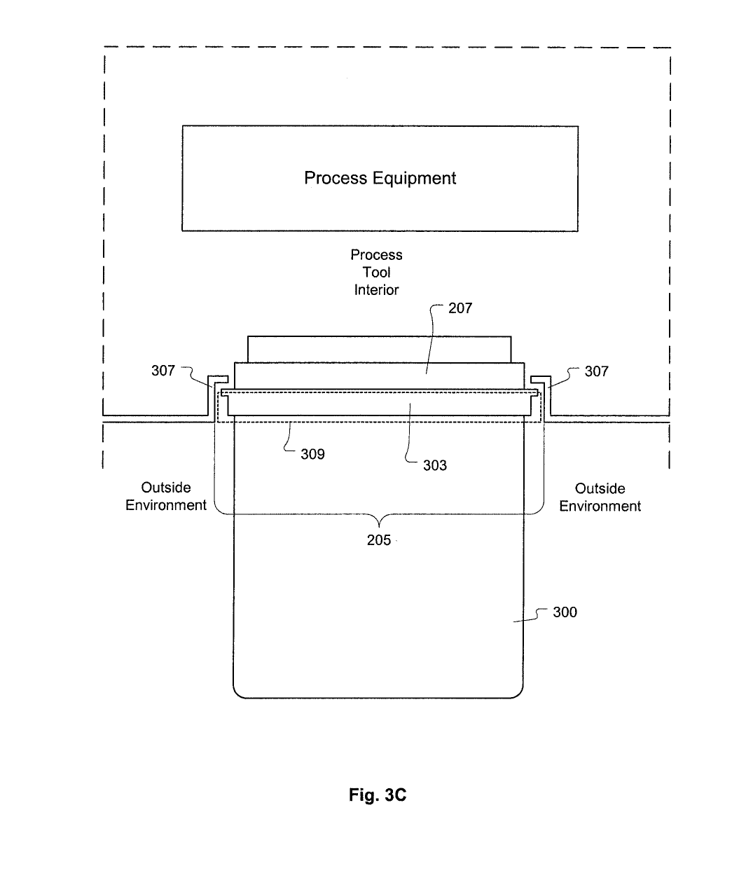

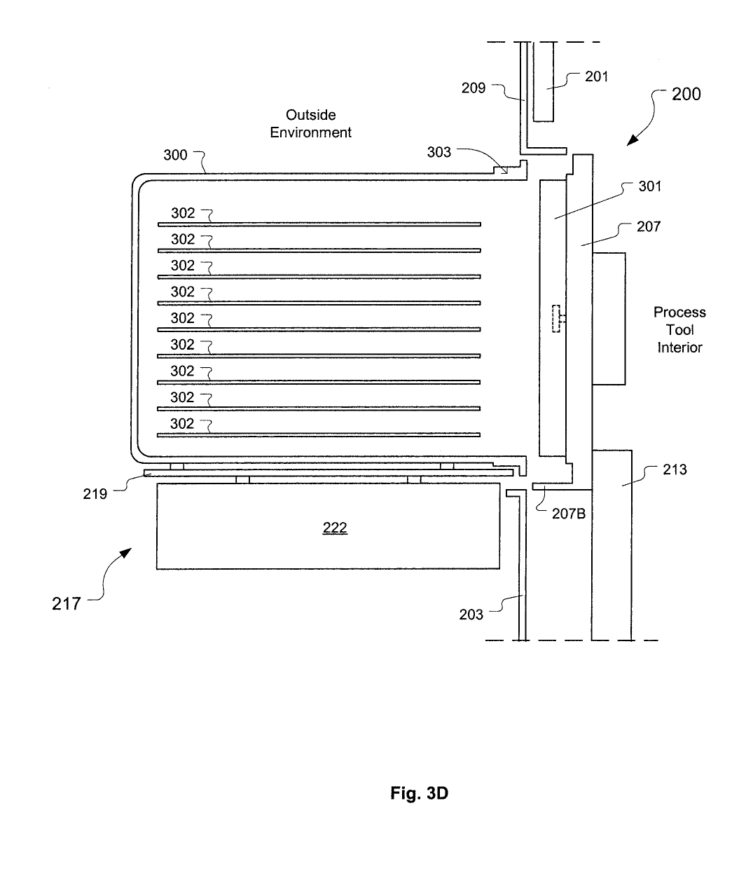

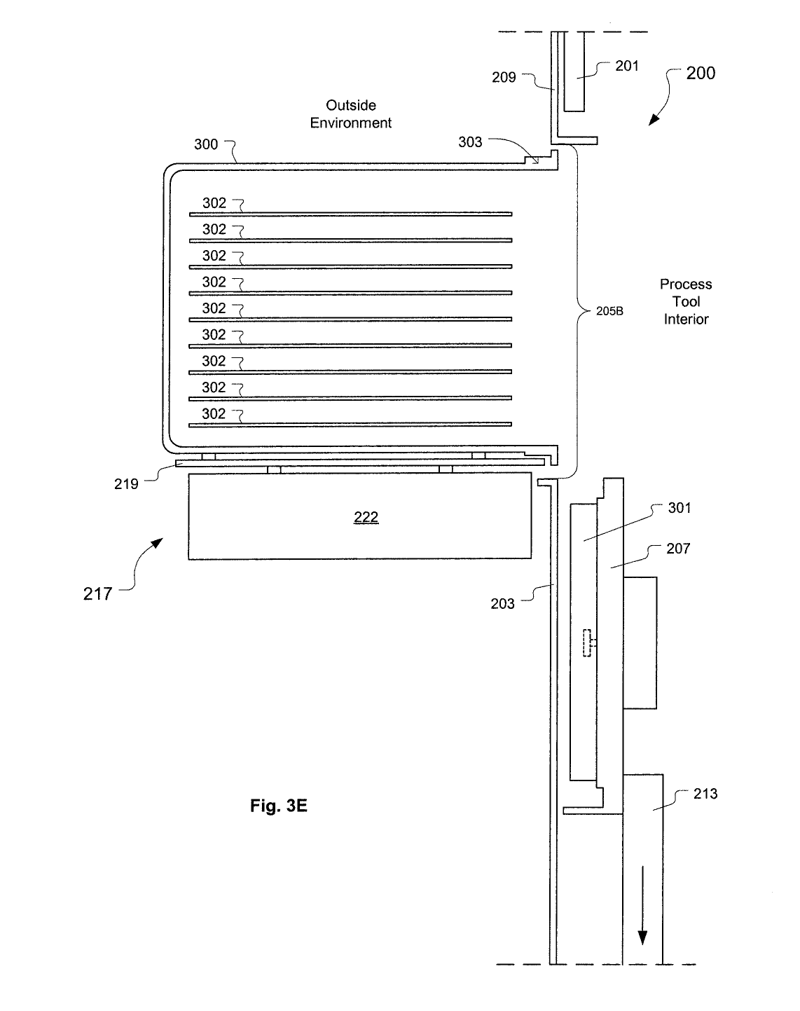

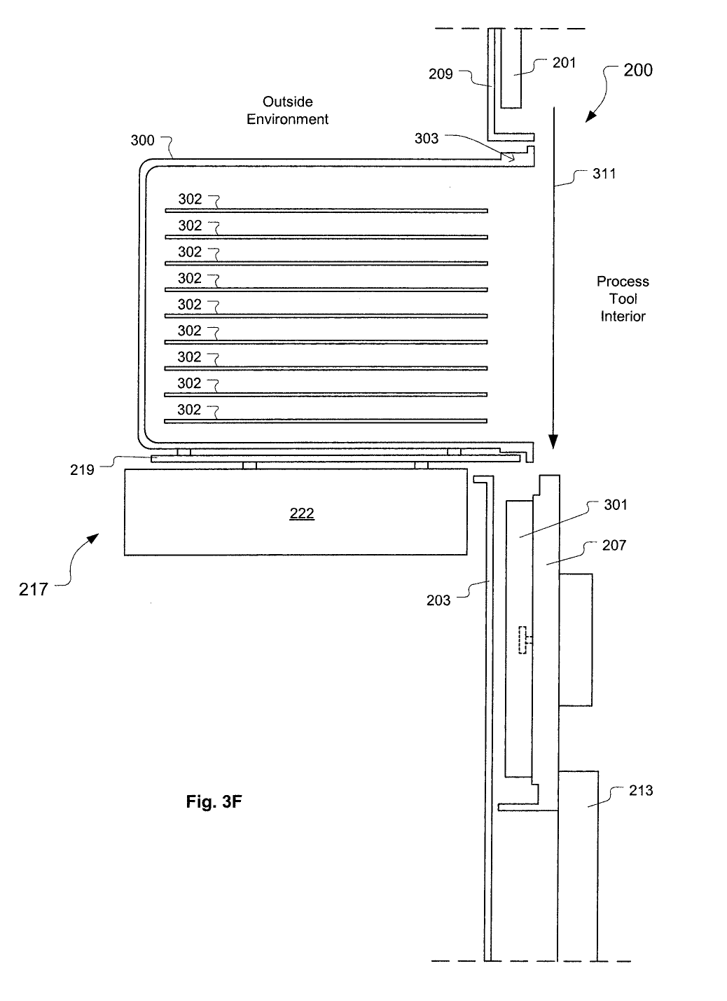

FIG. 3A is an illustration showing the load port 200 with a container 300 positioned on the advance plate 219 of the advance plate assembly 217, in accordance with one embodiment of the present invention. The container 300 is equipped with a mechanically openable door 301, such as that present in a FOUP. As previously mentioned, it should be understood that the container 300 can be essentially any type of container defined to house a number of workpieces 302 and equipped with a mechanically openable door. In various embodiments, the container 300 is either manually or automatically loaded on the advance plate 219. In one embodiment, sensors in the load port 200 detect the presence of the container 300 on the advance plate 219, and send a signal to the horizontal positioning device 222 to move the advance plate 219, with container 300 thereon, toward the port door 207.

FIG. 3B is an illustration showing the advance plate 219 moved toward the port door 207 so as to position the container door 301 adjacent to the front surface 207A of the port door 207, in accordance with one embodiment of the present invention. In one embodiment, positioning of the container door 301 adjacent to the front surface 207A of the port door 207 is accomplished by moving the advance plate 219 toward the port door 207 by a fixed distance. This fixed distance corresponds to a known distance between the front surface 207A of the port door 207 and the expected location of the container door 301, wherein the expected location of the container door 301 is determined by a known spatial relationship between the container door 301 location and the advance plate 219 position when the container 300 is loaded on the advance plate 219.

In one embodiment, a spacing between the front surface 207A of the port door 207 and the container door 301 is dynamically determined by a closed loop servo positioning system that includes a position compensation assembly and a controller, such as disclosed in U.S. Pat. No. 6,530,736, entitled “SMIF Load Port Interface Including Smart Port Door,” which is assigned to Asyst Technologies, Inc., and is incorporated herein by reference in its entirety. In this embodiment, as the advance plate 219 moves the container 300 toward the port door 207, the outer surface of the container door 301 eventually contacts a plunger extending from the front surface 207A of the port door 207. When the plunger is contacted by the container door 301, the position compensation assembly in combination with the controller can identify the exact position of the container door 301 with respect to the front surface 207A of the port door 207. Based on the identified position of the container door 301 relative to the front surface 207A of the port door 207, the position of the port door 207 and/or the position of the container door 301 can be adjusted to compensate for any improper positioning of the container 300 on the advance plate 219 and/or warpage of the outer surface of the container door 301.

The position compensation assembly and controller can be programmed to follow various algorithms to control the container door 301-to-port door 207 spacing. For example, in one embodiment, the advance plate assembly 217 moves the advance plate 219 to a fully advanced position toward the port door 207. At some point during the movement of the advance plate 219 toward the port door 207, the container door 301 contacts the plunger on the front surface 207A of the port door 207 and pushes the plunger into the port door 207. As the plunger moves into the port door 207, a resistance and a voltage through a resistor sensing circuit affixed to the plunger is caused to change. A precise relationship between the resistor sensing circuit electrical properties, e.g., voltage, and the position of the plunger is stored in a memory of the controller. Therefore, by monitoring the resistor sensing circuit electrical properties, the precise position of the plunger can be determined, and correspondingly the precise distance between the outer surface of the container door 301 and the front surface 207A of the port door 207 can be determined.

Additionally, the target resistor sensing circuit electrical properties, e.g., target voltage, corresponding to the proper position of the container door 301 relative to the port door 207 can be stored in the memory of the controller. Based on comparison of the monitored resistor sensing circuit electrical properties to the target resistor sensing circuit electrical properties, the horizontal positioning device 222 of the advance plate assembly 217 can be controlled to move the advance plate 219 toward or away from the port door 207 as necessary to achieve the proper position of the container door 301 relative to the port door 207.

In another embodiment, the horizontal positioning device 222 moves the advance plate 219 toward the port door 207 so that the outer surface of the container door 301 is positioned against the front surface 207A of the port door 207. In this embodiment, the horizontal positioning device 222 moves the advance plate 219 toward the port door 207 until proximity switches on the port door 207 activate. The position of the advance plate 219 is captured at the moment of activation of the port door 207 proximity switches. Then, the advance plate 219 retracts slightly and moves forward to stop at the proper position for engaging the port door 207 to the container door 301.

When the container door 301 is positioned adjacent to the port door 207, the latch keys 211 of the port door 207 are inserted into corresponding receptacles, e.g., slots, in the container door 301. In one embodiment, the latch keys 211 are part of a twist-and-pull latching mechanism, such as that disclosed in U.S. Pat. No. 6,502,869, entitled “Pod Door to Port Door Retention System,” or U.S. Pat. No. 4,995,430, entitled “Sealable Transportable Container Having Improved Latch Mechanism,” both of which are assigned to Asyst Technologies, Inc. and are incorporated herein by reference in their entirety. In this embodiment, once the latch keys 211 are inserted into the corresponding receptacles of the container door 301, the latch keys 211 are rotated to lock the latch keys 211 in their receptacles, thereby securing the container door 301 against the port door 207. Also, as the latch keys 211 are rotated within the container door 301, the latch keys 211 interact with a mechanism in the container door 301 to disengage latches within the container door 301 from a flange 303 of the container 300, thereby releasing the container door 301 from the container 300. It should be understood that although the twist-and-pull latch key mechanism is identified as one possible means for releasing the container door 301 from the container 300 and securing the container door 301 to the port door 207, other types of latch key mechanisms may be utilized in other load port 200 embodiments to provide an equivalent releasing and securing of the container door 301.

In one embodiment, the port door 207 includes a recessed region defined around a perimeter of its front surface 207A so as prevent or reduce contact between the port door 207 and the container flange 303, when the container 300 is moved adjacent to the port door 207. Prevention or reduction of contact between the port door 207 and the container flange 303 provides for reduced particulate generation at the port door 207 surface regions that are not covered by the container door 301 when the container door 301 is secured to the port door 207. It should be understood, however, that although the recessed region defined around the perimeter of the front surface 207A of the port door 207 is beneficial, the recessed region is not required. Therefore, in other embodiments, the front surface 207A of the port door 207 may extend to an outermost perimeter of the port door 207 without a surrounding recessed region.

Additionally, with regard to FIG. 3B, it should be appreciated that the vertical position of the seal plate 209 is adjusted such that when the container 300 is moved adjacent to the port door 207, the horizontally oriented plate 209B of the seal plate 209 is located above the container 300 and forms a proximity seal with an upper edge of the container flange 303. With the container 300 positioned adjacent to the port door 207, such as shown in FIG. 3B, the proximity seals defined between the port door 207/container 300 and the periphery of the effective aperture 205B allow gas from the higher pressure process tool interior to flow through the proximity seals to the lower pressure outside environment, as indicated by arrows 305.

FIG. 3C is an illustration showing a top view of the container 300 positioned adjacent to the port door 207, as shown in FIG. 3B, in accordance with one embodiment of the present invention. The sides of the aperture 205 are defined by side seal plates 307. The side seal plates 307 are configured to form a proximity seal with the port door 207 and the container flange 303, when present. Unlike the seal plate 209 at the upper portion 205A of the aperture 205, the side seal plates 307 may be fixed as opposed to adjustable. The seal plate 209 is defined to fit within the side seal plates 307. For example, the outline of the seal plate 209 as represented by the dotted line 309 is shown to fit within the side seal plates 307. In one embodiment, the width of the seal plate 209 is defined to be slightly smaller than the distance between the side seal plates 307 within which the seal plate 209 is disposed.

Also, in one embodiment, the seal plate 209 is positioned so that the edge of the seal plate 209 that is located closest to the process tool interior is positioned slightly outside the vertical plane corresponding to the front of the container flange 303 that faces toward the process tool interior. Additionally, as shown in the embodiment of FIG. 3C, the side seal plates 307 are configured to overlap the front of the container flange 303, thereby reducing particulate contamination of the process tool interior caused by the front of the container flange 303. It should be understood, however, that the overlap of the front of the container flange 303 by the side seal plates 307 is not required. Therefore, in other embodiments, the side seal plates 307 may extend toward the process tool interior without turning to overlap the front of the container flange 303.

Once the container door 301 is secured to the port door 207, the horizontal positioning device 222 operates to horizontally move the advance plate 219 away from the port door 207, thereby removing the container door 301 from the container 300, and clearing the container flange 303 from a vertical movement path of the container door 301. FIG. 3D is an illustration showing the container 300 moved away from the port door 207 after securing the container door 301 to the port door 207, in accordance with one embodiment of the present invention. Again, the port door extension 207B forms a proximity seal between the port door 207 and the BOLTS plate 203, and between the port door 207 and the bottom of the container flange 303.

Once the container 300 is retracted away from the port door, as shown in FIG. 3D, the port door 207 with the container door 301 secured thereto is moved vertically downward by the vertical positioning device 213, so as to clear the effective aperture 205B and enable unobstructed access from the process tool interior to the workpieces 302 inside the container 300. FIG. 3E is an illustration showing the port door 207 with the container door 301 secured thereto moved vertically downward by the vertical positioning device 213, in accordance with one embodiment of the present invention. It should be appreciated that during the vertical movement of the port door 207, there is no significant horizontal movement of the port door 207. Moreover, the load port 200 does not provide for intentional horizontal movement of the port door 207.

In one embodiment, after the port door 207 is lowered as shown in FIG. 3E, the container 300 may be moved toward the process tool interior, by way of the advance plate assembly 217, prior to accessing the workpieces 302 within the container 300. In this embodiment, the container 300 is moved toward the process tool interior, i.e., forward, until the container 300 is in substantially the same position at which it previously interfaced with the port door 207. FIG. 3F is an illustration showing the container 300 in the forward position following removal of the container door 301 and lowering of the port door 207 having the container door 301 secured thereto, in accordance with one embodiment of the present invention. The forward position of the container 300 reduces the reach required of a workpiece transfer device within the process tool interior.

Also, the forward position of the container 300 improves clean air laminar flow across the opening of the container 300 during the time the container 300 is open. For example, with the container 300 in the forward position, a downward clean air flow across the opening of the container 300, as indicated by arrow 311, is less disturbed by the seal plate 209 and is less impeded by the port door 207/container door 301 combination present below the opening of the container 300. It should be understood, however, that although movement of the opened container 300 to the forward position is beneficial, this movement is not required. Therefore, in other embodiments, the container 300 may be retained at the retracted position as shown in FIG. 3E, or any other position appropriate for the process tool, whereby an appropriate proximity seal is maintained between the container flange 303 and the periphery of the effective aperture 205B. Additionally, it should be appreciated that to return the container door 301 to the container 300, the process described with regard to FIGS. 3A-3F is performed in reverse order.

The load port 200 is uniquely equipped with a variable-size capability to enable accommodation of containers of various size. For example, the vertical closed position of the port door 207 can be adjusted to enable alignment of the latch keys 211 of the port door 207 to corresponding receptacles in the container positioned on the advance plate 219. Also, the vertical position of the seal plate 209 can be adjusted so that the horizontally oriented plate 209B of the seal plate 209 forms a proximity seal with the container flange when the container flange is positioned under the seal plate 209. As previously mentioned, in various embodiments, the vertical position of the seal plate 209 can be adjusted either manually or remotely. Additionally, in one embodiment, the vertical position adjustment of the seal plate 209 may be performed automatically through sensing of the vertical position of the upper surface of the container flange relative to the seal plate 209.

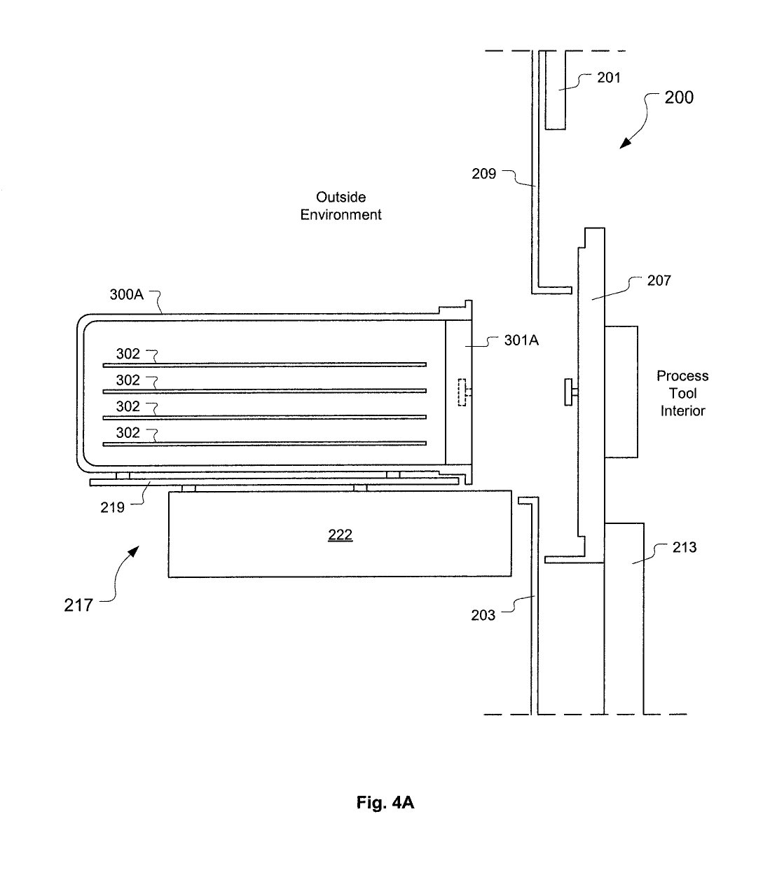

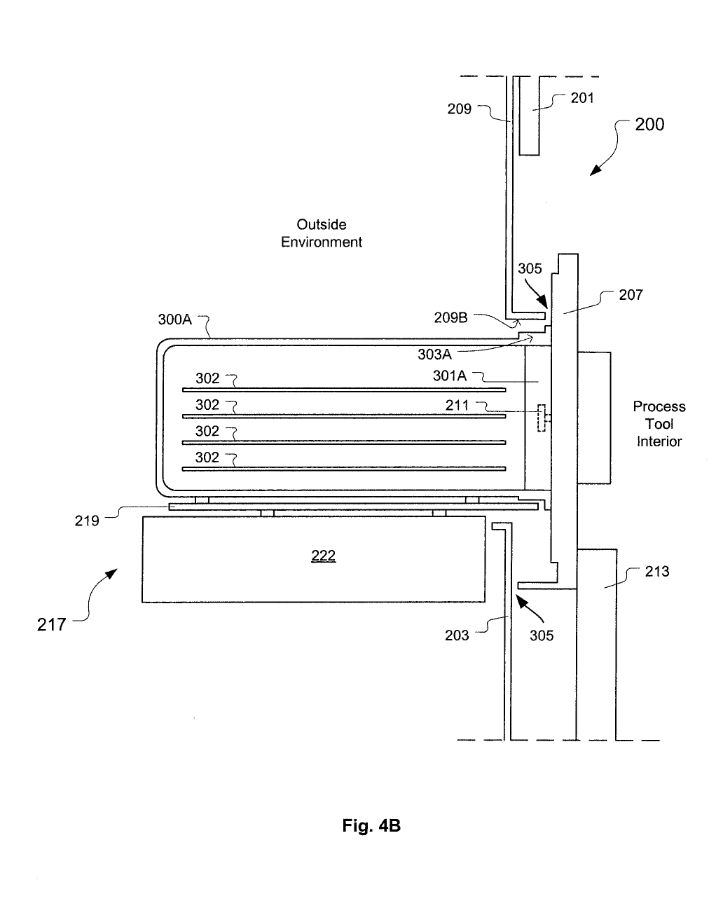

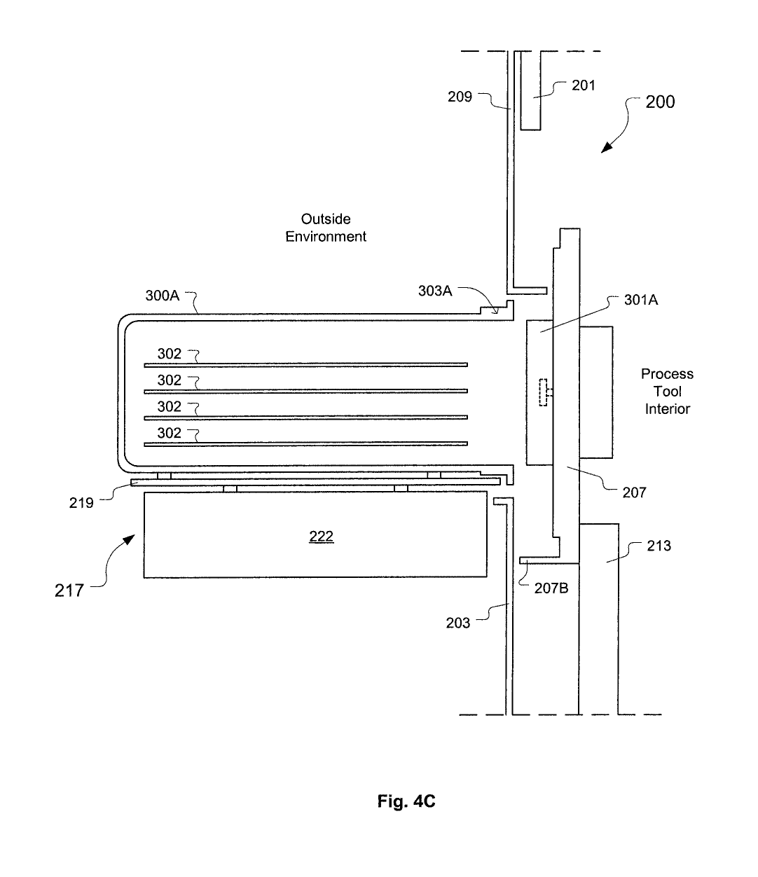

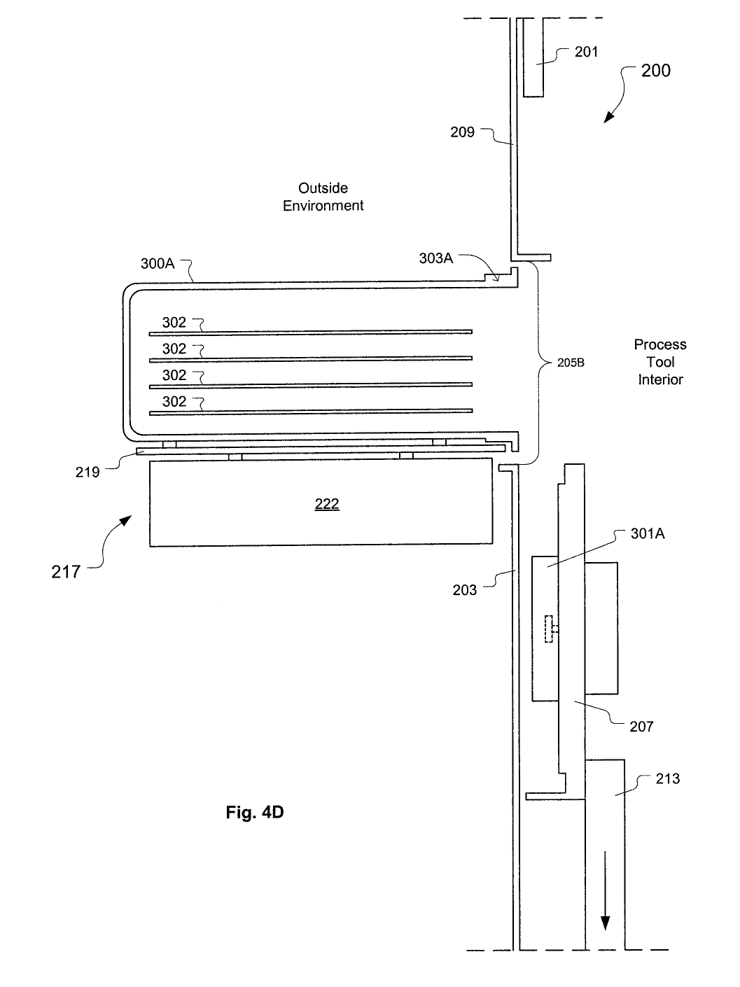

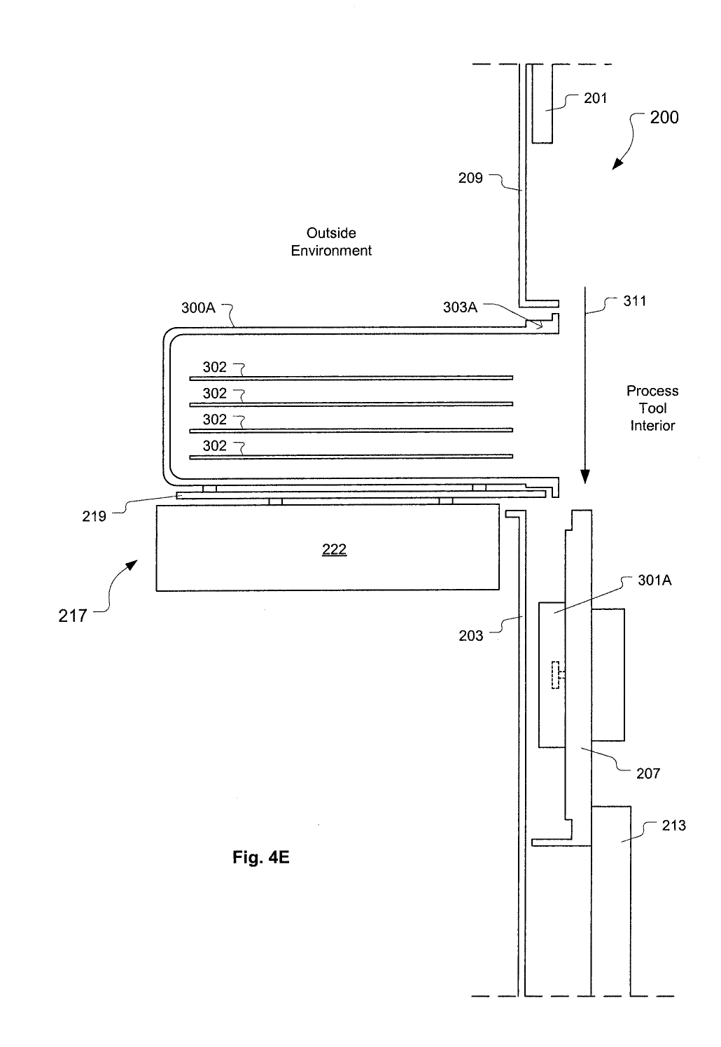

FIG. 4A is an illustration showing the load port 200 with a low-capacity container 300A positioned on the advance plate 219 of the advance plate assembly 217, in accordance with one embodiment of the present invention. As compared to the container 300 of FIG. 3A, the low-capacity container 300A has different dimensions, such as a reduced vertical height. Therefore, as shown in FIG. 4A, the vertical position of the seal plate 209 is lowered to enable formation of a proximity seal between the seal plate 209 and the container flange 303A when the container flange 303A is positioned under the seal plate 209. Also, the vertical closed position of the port door 207 is lowered to enable alignment of the latch keys 211 of the port door 207 to corresponding receptacles in the container 300A positioned on the advance plate 219.

It should be appreciated that once the vertical position of the seal plate 209 and the closed vertical position of the port door 207 are adjusted to accommodate the container present on the advance plate 219, the load port 200 is operated in the same manner as previously described with regard to FIGS. 3A-3F. FIG. 4B is an illustration showing the advance plate 219 moved toward the port door 207 so as to position the low-capacity container door 301A adjacent to the front surface 207A of the port door 207, in accordance with one embodiment of the present invention. The operations of the load port 200 as previously described with regard to FIG. 3B are equally applicable to FIG. 4B. FIG. 4C is an illustration showing the low-capacity container 300 moved away from the port door 207 after securing the low-capacity container door 301A to the port door 207, in accordance with one embodiment of the present invention. The operations of the load port 200 as previously described with regard to FIG. 3D are equally applicable to FIG. 4C.

FIG. 4D is an illustration showing the port door 207 with the low-capacity container door 301A secured thereto moved vertically downward by the vertical positioning device 213, in accordance with one embodiment of the present invention. The operations of the load port 200 as previously described with regard to FIG. 3E are equally applicable to FIG. 4D. FIG. 4E is an illustration showing the low-capacity container 300A in the forward position following removal of the low-capacity container door 301A and lowering of the port door 207 having the low-capacity container door 301 secured thereto, in accordance with one embodiment of the present invention. The operations of the load port 200 as previously described with regard to FIG. 3F are equally applicable to FIG. 4E.

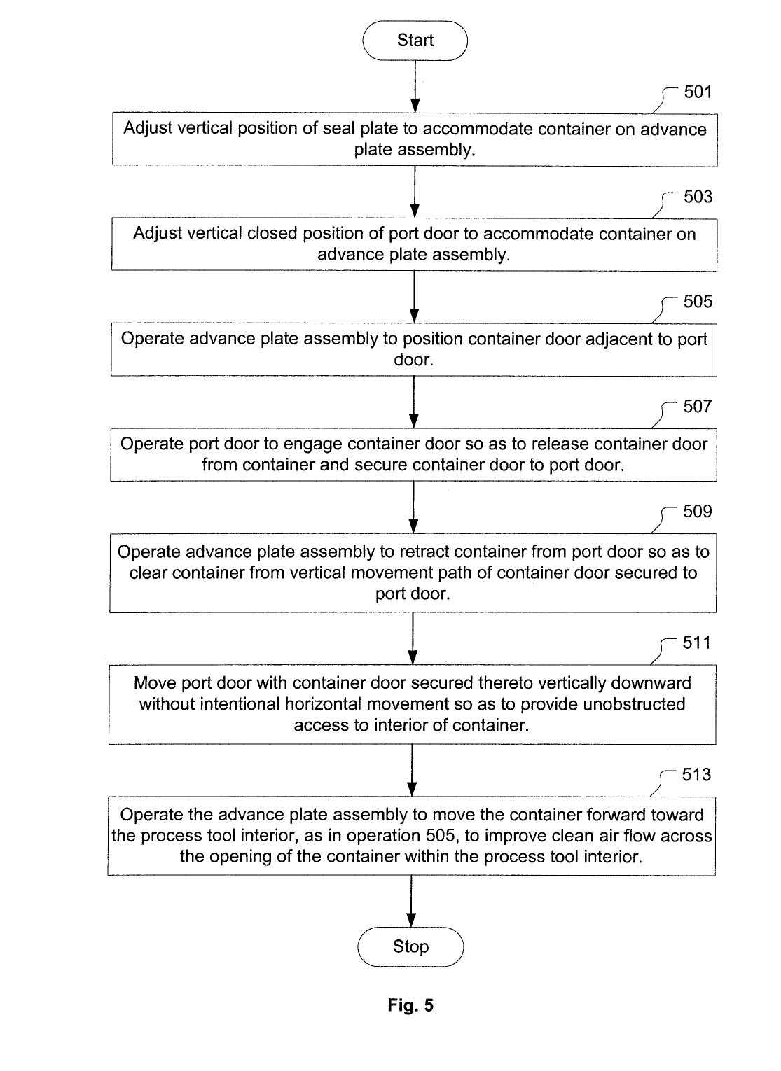

FIG. 5 is an illustration showing a method for operating the load port 200, in accordance with one embodiment of the present invention. The method includes an operation 501 for adjusting the vertical position of seal plate 209 to accommodate the container on the advance plate assembly 217. As previously discussed the vertical position of the seal plate 209 is adjusted so that the seal plate 209 forms a proximity seal with the upper surface of the container flange when the container flange is positioned below the seal plate 209. The method also includes an operation 503 for adjusting the vertical closed position of port door 207 to accommodate the container on the advance plate assembly 217. As previously discussed, the vertical closed position of the port door 207 is adjusted so that the latch keys 211 of the port door 207 align properly with the corresponding receptacles in the container door. It should be understood that operations 501 and/or 503 can be performed either manually or remotely. Also, remotely performed operations 501 and/or 503 can be either manually or automatically controlled. Additionally, operations 501 and/or 503 can be facilitated by operating sensors and associated circuitry/mechanics to detect a vertical extent of the container flange relative to the advance plate assembly 217. Moreover, operations 501 and 503 can be performed either sequentially or at the same time.

Following operations 501 and 503, the method continues with an operation 505 for operating the advance plate assembly 217 to position the container door adjacent to port door 207. An operation 507 is then performed in which the port door 207 is operated to engage the container door so as to release the container door from the container and secure the container door to the port door 207. In one embodiment, operation 507 is performed by operating a latch key mechanism within the port door 207 so that the latch keys 211 engage the container door, thereby causing the container door to release from the container. Following operation 507, an operation 509 is performed in which the advance plate assembly 217 is operated to retract the container from the port door 207 so as to clear the container from a vertical movement path of the container door that is secured to the port door 207.

Following operation 509, an operation 511 is performed to move the port door 207, with the container door secured thereto, vertically downward without intentional horizontal movement of the port door 207, so as to provide unobstructed access to the interior of the container from the process tool interior. In one embodiment, the method can further include an optional operation 513 in which the opened container is moved forward toward the process tool interior to the horizontal position at which the container door would be adjacent to the port door 207, if the container door was present in the container and the port door 207 was in the closed vertical position, such as in operation 505. This optional operation 513 may provide for less disturbed clean air flow across the opening of the container within the process tool interior. The method may also include performing each of operations 501-513 in reverse order so as to return the container door to the container and place the port door 207 in the closed vertical position.

While this invention has been described in terms of several embodiments, it will be appreciated that those skilled in the art upon reading the preceding specifications and studying the drawings will realize various alterations, additions, permutations and equivalents thereof. Therefore, it is intended that the present invention includes all such alterations, additions, permutations, and equivalents as fall within the true spirit and scope of the invention.

What is claimed is:

1. A load port door, comprising:
a planar member defined to cover an effective aperture of a load port, the planar member oriented to be substantially vertical, the vertically oriented planar member defined by an upper surface, a lower surface, opposing side surfaces, a front surface, and a back surface, wherein the front surface of the planar member is defined to interface with a door of a container when present, and wherein the bottom surface of the planar member includes an extension extending perpendicularly away from the front surface of the planar member; and
a vertical positioning device connected to the planar member to provide for controlled vertical positioning and movement of the planar member without substantial horizontal movement of the planar member.

2. A load port door as recited in claim 1, wherein the planar member includes a recessed region defined around an outer periphery of the front surface of the planar member so as to prevent contact between the planar member and a flange of the container when the container is moved adjacent to the planar member such that the door of the container contacts the front surface of the planar member.

3. A load port door as recited in claim 1, wherein the extension of the bottom surface of the planar member is defined to form a proximity seal with a vertical plate positioned below the effective aperture of the load port.

4. A load port door as recited in claim 1, wherein the upper surface of the planar member is defined to form a proximity seal with a seal plate positioned above the effective aperture of the load port.

5. A load port door as recited in claim 1, wherein the vertical positioning device is defined to vertically position the planar member to align with the door of the container so as to enable engagement of the door of the container to the planar member when the container is horizontally moved adjacent to the planar member such that the door of the container contacts the front surface of the planar member.

6. A load port door as recited in claim 1, further comprising:
a sensor defined to generate and transmit a signal to the vertical positioning device, wherein the signal directs the vertical positioning device to vertically position the planar member to align with the door of the container.

7. A load port door as recited in claim 1, wherein the planar member includes a number of latch keys extending outward from the front surface of the planar member, the number of latch keys defined to interface with corresponding receptacles in the door of the container to enable engagement of the door of the container to the planar member when the container is horizontally moved adjacent to the planar member such that the door of the container contacts the front surface of the planar member.

8. A load port for supplying a workpiece to process equipment that interfaces with the load port, comprising:
a port door defined to cover an effective aperture of the load port;
a vertical positioning device connected to the port door to provide for controlled vertical positioning and movement of the port door without substantial horizontal movement of the port door; and
a seal plate disposed above the port door, the seal plate defined to form a proximity seal with an upper surface of the port door when the port door is vertically positioned in proximity to the seal plate, wherein the seal plate is defined to be adjustable in a vertical direction.

9. A load port as recited in claim 8, wherein the port door includes a front surface defined to interface with a door of a container, the front surface of the port door including a bottom extension extending in a substantially perpendicular direction away from the front surface of the port door, the bottom extension defined to form a proximity seal with a vertical plate positioned below the effective aperture of the load port.

10. A load port as recited in claim 8, wherein the port door includes a front surface defined to interface with a door of a container when present, the container configured to house a number of workpieces, the front surface of the port door including a recessed region defined around an outer periphery of the front surface of the port door so as to prevent contact between the port door and a flange of the container when the container is moved adjacent to the port door such that the door of the container contacts the front surface of the port door.

11. A load port as recited in claim 8, wherein the port door includes a front surface defined to interface with a door of a container, wherein the port door includes a number of latch keys extending outward from the front surface of the port door, the number of latch keys defined to interface with corresponding receptacles in the door of the container to enable engagement of the door of the container to the port door when the container is horizontally moved adjacent to the port door such that the door of the container contacts the front surface of the port door.

12. A load port as recited in claim 8, wherein the vertical positioning device is defined to vertically position the port door to align with a door of a container so as to enable engagement of the door of the container to the port door when the container is horizontally moved adjacent to the port door such that the door of the container contacts the front surface of the port door.

13. A load port as recited in claim 8, wherein the seal plate is defined to be vertically adjusted in a remote manner to enable remote adjustment of a vertical extent of the effective aperture of the load port.

14. A load port as recited in claim 8, further comprising:
an advance plate assembly including an advance plate and a horizontal positioning device, wherein the advance plate is defined to receive and support a container to be interfaced with the port door, and wherein the horizontal positioning device is defined to provide for controlled horizontal positioning and movement of the advance plate with the container thereon relative to the port door.

15. A method for operating a load port, comprising:
a) adjusting a vertical position of a seal plate so as to form a proximity seal between the seal plate and a container when the container is positioned under the seal plate;
b) adjusting a vertical closed position of a port door to align with the container when the container is positioned adjacent to the port door;
c) moving the container horizontally toward the port door so as to position a door of the container adjacent to the port door, wherein the port door is in the vertical closed position;
d) operating the port door to engage the container door so as to release the container door from the container and to secure the container door to the port door;
e) retracting the container horizontally away from the port door without substantial horizontal movement of the port door so as to open the container and clear the container from a vertical movement path of the container door secured to the port door; and
f) moving the port door with the container door secured thereto vertically downward without substantial horizontal movement of the port door so as to provide unobstructed access to an interior of the opened container.

16. A method for operating a load port as recited in claim 15, further comprising:
following operation f), moving the opened container horizontally toward a location vacated by the port door so as to provide for less disturbed clean air flow across an opening of the container.

17. A method for operating a load port as recited in claim 15, further comprising:
performing operations a) through f) in reverse order to close the container and return the port door to the vertical closed position.

18. A method for operating a load port as recited in claim 15, wherein either operation a), b), or both operations a) and b) is performed remotely.

19. A method for operating a load port as recited in claim 15, further comprising:
operating one or more sensors to determine a vertical position and a vertical extent of the container; and
using the determined vertical position and vertical extent of the container to automatically perform either operation a), b), or both operations a) and b).

20. A method for operating a load port as recited in claim 15, wherein operations a) through f) are performed without any intentional horizontal movement of the port door.
